(19) United States
(12) Patent Application Publication
(10) Pub. No.: US 2017/0110981 A1
(43) Pub. Date: Apr. 20, 2017

(54) Power Conversion Method and Power Converter

(71) Applicant: Infineon Technologies Austria AG, Villach (AT)

(72) Inventor: Gerald Deboy, Klagenfurt (AT)

(21) Appl. No.: 14/885,945

(22) Filed: Oct. 16, 2015

(51) Int. Cl. H02M 7/217

(52) U.S. Cl. CPC H02M 7/217

(57) ABSTRACT

A power converter and a method for operating a power converter are disclosed. In an embodiment the method for operating a power converter includes maintaining a first electronic switch switched off and an inductor demagnetized for a pause period before at least one of the plurality of drive cycles, pre-magnetizing the inductor connected in series with the first electronic switch, and discharging a parasitic capacitance of the first electronic switch using energy stored in the inductor by pre-magnetizing. The method further includes after discharging the parasitic capacitance, switching on for an on-period the first electronic switch.

### TECHNICAL FIELD

The present disclosure relates to a power converter and a power conversion method, in particular to operating a power converter under light-load conditions.

### BACKGROUND

Switched mode power converters (switched mode power supplies, SMPS) are widely used for power conversion in automotive, industrial, or consumer electronic applications. A switched-mode power converter includes at least one electronic switch and at least one inductor. An input power received by the power converter and, therefore, an output power provided by the power converter can be controlled by a switched-mode operation of the at least one electronic switch. The inductor acts as a buffer that magnetically stores energy received from an input of the power converter when the electronic switch is in an on-state and forwards the stored energy to an output when the electronic switch is in an off-state.

The size of the inductor constitutes a significant portion of the power converter's overall size. Thus, in order to reduce the overall size, it may be desirable to reduce the size of the inductor. As the capability of an inductor to magnetically store energy decreases as the size decreases, reducing the inductor size makes it necessary to increase the switching frequency. The switched-mode operation of the at least one electronic switch is associated with losses, which are usually referred to as switching losses. These switching losses increase as the switching frequency increases. Basically, it is desirable to have low switching losses to obtain a high efficiency of the power converter. In particular, it is desirable to have a high efficiency even under low-load conditions where an output power of the power converter is significantly below a rated power.

### SUMMARY

One example relates to a method. The method includes in at least one of a plurality of drive cycles of a power converter, pre-magnetizing an inductor connected in series with a first electronic switch, discharging a parasitic capacitance of the first electronic switch using energy stored in the inductor by the pre-magnetizing, and after discharging the parasitic capacitance, switching on for an on-period the first electronic switch. Furthermore, the method includes before at least one of the plurality of drive cycles of the power converter, maintaining the first electronic switch switched off and the inductor demagnetized in a pause period.

Another example relates to a power converter. The power converter includes an inductor connected in series with a first electronic switch, and a control circuit. The control circuit is configured, in at least one of a plurality of drive cycles, to control pre-magnetizing the inductor, discharging a parasitic capacitance of the first electronic switch using energy stored in the inductor by the pre-magnetizing, and, after discharging the parasitic capacitance, switching on for an on-period the first electronic switch. Furthermore, the control circuit is configured, before at least one of the plurality of drive cycles, to maintain the first electronic switch switched off and the inductor demagnetized for a pause period.

### BRIEF DESCRIPTION OF THE DRAWINGS

Examples are explained below with reference to the drawings. The drawings serve to illustrate certain principles, so that only aspects necessary for understanding these principles are illustrated. The drawings are not to scale. In the drawings the same reference characters denote like features.

FIG. 1 shows a power converter with a boost topology according to one example;

FIGS. 2A-2B show examples of how electronic switches in the power converter can be implemented;

FIG. 3 shows one example of a control circuit in the power converter;

FIGS. 4A-4D show signal waveforms that illustrate one operation mode (light-load mode) of the power converter, wherein in this operation mode there is a pause period before a cycle period;

FIGS. 5-6 show signal waveforms that illustrate different operation modes based on the operation mode shown in FIGS. 4A-4D;

FIGS. 7A-7C show signal waveforms illustrating another operation mode based on the operation mode shown in FIGS. 4A-4D;

FIG. 8 show signal waveforms that illustrate adjusting a duration of the pause period by valley switching;

FIG. 9 illustrates a duration of the pause period over an output power of the power converter if valley switching is employed;

FIG. 10 illustrates a switching frequency over the output power of the power according to one example;

FIG. 11 illustrates the switching frequency over the output power of the power according to another example;

FIG. 12 shows timing diagrams of an input current of the power converter based on an input voltage;

FIG. 13 shows another example of the control circuit in the power converter;

FIGS. 14A-14B show timing diagrams that illustrate variations of an input voltage and corresponding variations of an input power in a power converter with a PFC (Power Factor Correction) capability;

FIGS. 15A-15B show a switching frequency over a phase angle of a sinusoidal input voltage both in a conventional power converter and a power converter operating in accordance with one of the methods shown in FIGS. 4A-12;

FIG. 16 shows a power converter with a boost topology according to another example;

FIGS. 17A-17C shows timing diagrams illustrating one way of operation of the power converter shown in FIG. 16; and

FIG. 18 shows a power converter with a buck topology according to one example.

### DETAILED DESCRIPTION OF ILLUSTRATIVE EMBODIMENTS

In the following detailed description, reference is made to the accompanying drawings. The drawings form a part of the description and by way of illustration show specific examples in which the invention may be practised. It is to be understood that the features of the various examples described herein may be combined with each other, unless specifically noted otherwise.

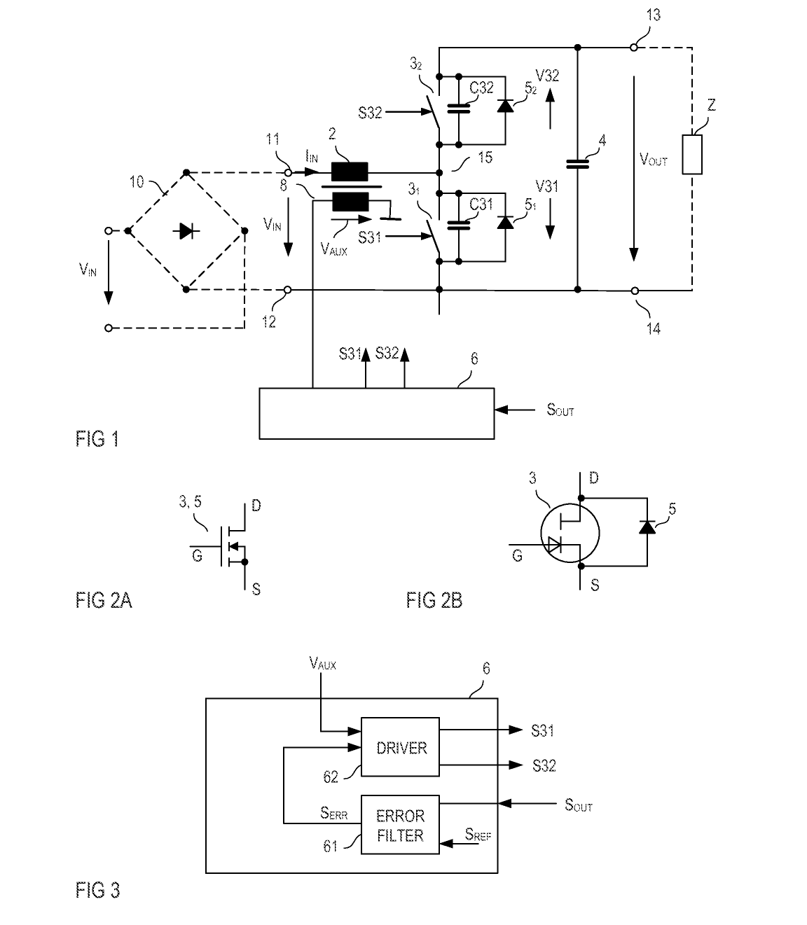

FIG. 1 shows a power converter (switched-mode power supply, SMPS) according to one example. The power converter, which may also be referred to as voltage converter, includes an input configured to receive an input voltage V_{IN} and an input current I_{IN}, and an output configured to provide an output voltage V_{OUT} and an output current I_{OUT}. A load Z (illustrated in dashed lines in FIG. 1) can be connected to the output to receive the output voltage V_{OUT} and the output current I_{OUT}. According to one example, the power converter is configured to regulate one of the output voltage V_{OUT} and the output current I_{OUT} such that a signal level of the one of the output voltage V_{OUT} and the output current I_{OUT} substantially equals a predefined reference level.

The power converter shown in FIG. 1 includes a boost topology. However, implementing the power converter with a boost topology is only an example. The operation modes explained herein below can be used in a power converter with another topology such as a buck topology or a buck-boost topology as well. This is explained in further detail below.

Referring to FIG. 1, the power converter shown in FIG. 1 includes an inductor (inductive storage element) 2 such as a choke, and a first electronic switch 3₁ connected in series with the inductor 2. A series circuit with the inductor 2 and the first electronic switch 3₁ is connected to the input. In particular, the series circuit is connected between a first input node 11 and a second input node 12 of the input. The output voltage V_{OUT} is available across a capacitor 4, which will be referred to as output capacitor 4 in the following. The output capacitor 4 is connected to the output. In particular, the output capacitor 4 is connected between a first output node 13 and a second output node 14 of the output. A rectifier 3₂, 5₂ is connected between the inductor 2 and the output capacitor 4. In particular, in this example, the rectifier 3₂, 5₂ is connected between a circuit node 15 common to inductor 2 and the first electronic switch 3₁ and the first output node 13. The rectifier 3₂, 5₂ includes a second electronic switch 3₂ and a rectifier element 5₂ such as a diode connected in parallel with the second electronic switch 3₂. This rectifier will be referred to as synchronous rectifier (SR) in the following.

According to one example, a rectifier element 5₁ such as a diode can be connected in parallel with the first electronic switch 3₁. In context with the first electronic switch 3₁ as well as the second electronic switch 3₂ “connected in parallel” means connected in parallel with a load path of the respective switch 3₁, 3₂. The first electronic switch 3₁ can be controlled by receiving a first drive signal S31 at a control node, and the second electronic switch 3₂ can be controlled by receiving a second drive signal S32 at a control node. Each of the first electronic switch 3₁ and the second electronic switch 3₂ can be a conventional electronic switch such as, for example, a MOSFET (Metal Oxide Semiconductor Field-Effect Transistor), an IGBT (Insulated Gate Bipolar Transistor), a BJT (Bipolar Junction Transistor), a JFET (Junction Field-Effect Transistor), a HEMT (High Electron-Mobility Transistor), or the like. FIG. 2A shows one example of the first electronic switch 3₁ or the second electronic switch 3₂ implemented as a MOSFET. In FIG. 3, reference character 3 denotes one of the first electronic switch 3₁ and the second electronic switch 3₂. Referring to FIG. 2A, the MOSFET includes a gate node G, a drain node D, and a source node S. A load path of the MOSFET is an internal current path between the drain node D and the source node S, a control node of the MOSFET is the gate node. The MOSFET shown in FIG. 2A is drawn as an n-type enhancement MOSFET. This, however, is just an example; another type of MOSFET such as an n-type depletion MOSFET or a p-type enhancement or depletion MOSFET can be used as well. A MOSFET includes an internal diode, which is usually referred to as body diode. This body diode can be used as the rectifier element (see reference characters 5₁, 5₂ in FIG. 1) connected in parallel with the respective switch 3 so that no additional rectifier element is required when the electronic switch 3 is implemented as a MOSFET. That is, the MOSFET forms the respective electronic switch 3 and the rectifier element 5 connected in parallel with the respective electronic switch (that is, rectifier element 5₁ connected in parallel with the first electronic switch 3₁, or rectifier element 5₂ connected in parallel with the second electronic switch 3₂).

FIG. 2B shows one example of the electronic switch 3 implemented as a HEMT such as a GaN HEMT. The HEMT includes a gate node G, a drain node D, and a source node S. A load path of the HEMT is an internal current path between the drain node D and the source node S, a control node of the MOSFET is the gate node. Other than a MOSFET a HEMT does not include an internal diode between the drain node D and the source node S so that an additional element forming the rectifier element 5 is connected in parallel with the load path of the HEMT.

Referring to FIG. 1, the power converter further includes a control circuit 6 configured to generate the first drive signal S31 received by the control node of the first electronic switch 3₁ and the second drive signal S32 received by the control node of the second electronic switch 3₂. The control circuit 6 is configured to drive the first electronic switch 3₁ and the second electronic switch 3₂ based on an output signal S_{OUT}. The output signal S_{OUT} represents a signal level of the output parameter that is to be regulated. For example, this output parameter is the output voltage V_{OUT}, or the output current I_{OUT}. In the following, just for the purpose of explanation, it is assumed that the power converter is configured to regulate the output voltage V_{OUT}. In this case, the output signal S_{OUT} represents the voltage level of the output voltage V_{OUT}.

Basically, the power converter, controlled by the control circuit 6, is configured to regulate the output voltage V_{OUT} by a switched-mode operation (clocked operation) of the first electronic switch 3₁. Each time the control circuit 6 switches on the first electronic switch 3₁ energy received from the input 11, 12 is magnetically stored in the inductor 2. When the control circuit 6 switches off the first electronic switch 3₁ the energy previously stored in the inductor 2 is transferred via the synchronous rectifier 3₂, 5₂ to the output 13, 14, that is, to the output capacitor 4 and the load Z, respectively. This energy transfer via the synchronous rectifier 3₂, 5₂ may include switching on the second electronic switch 3₂. An average input power received from the input 11, 12 and transferred to the output 13, 14 can be adjusted by adjusting a duration of on-periods of the first electronic switch 3₁. “On-periods” of the first electronic switch 3₁ are those time periods in which the electronic switch 3₁ is switched on. For example, at a given voltage level of the input voltage V_{IN}, the average input power received from the input 11, 12 increases as the duration of those on-periods increases.

FIG. 3 schematically illustrates one example of the control circuit 6. In particular, FIG. 2 shows a block diagram of the control circuit 6 according to one example. It should be noted that such block diagram illustrates the functional blocks of the control circuit rather than the implementation of the control circuit. Those functional blocks can be implemented using dedicated circuitry. According to another example, the control circuit can be implemented using hardware and software such as a microcontroller and software running on the microcontroller. Referring to FIG. 3, the control circuit 6 includes an error filter 61, which receives the output signal S_{OUT} and a reference signal S_{REF}. The error filter 61 is configured to compare the output signal S_{OUT} with the reference signal S_{REF} and to generate an error signal S_{ERR} based on this comparison. In particular, the error filter 51 may generate the error signal S_{ERR} based on a difference S_{REF}−S_{OUT} between the error signal S_{REF} and the output signal S_{OUT}. The error filter 61 may have one of a proportional (P) characteristic, an integral (I) characteristic, and a proportional-integral (PI) characteristic. A drive circuit 62 receives the error signal S_{ERR} and is configured to drive the first electronic switch 3₁ and the second electronic switch 3₂ based on the error signal S_{ERR}.

Regulating the output voltage V_{OUT} by the control circuit 6 may include to increase the input power received from the input 11, 12 if the error signal S_{ERR} indicates that the output voltage V_{OUT} has decreased. This counteracts a further decrease of the output voltage V_{OUT} and helps to regulate the voltage level of the output voltage V_{OUT} such that it substantially equals a voltage level represented by the reference signal S_{REF}. Equivalently, the control circuit 6 may control the first electronic switch 3₁ such that the input power received from the input 11, 12 decreases if the error signals S_{ERR} indicates that the output voltage V_{OUT} has increased. This counteracts a further increase of the output voltage V_{OUT} and helps to regulate the voltage level of the output voltage V_{OUT} such that it substantially equals a voltage level represented by the reference signal S_{REF}. Variations of the output voltage V_{OUT} may result from a varying power consumption of the load Z.

Inevitably, operating the power converter is associated with power losses. That is, an average output power is not exactly equal an average input power but is less than the average input power. This is because of losses that occur in the power converter. For example, those losses include conduction losses but also include switching losses. “Conduction losses” are losses resulting from ohmic resistances of switches and conductors in the power converter. “Switching losses” are losses associated with the switched-mode operation of the electronic switches 3₁, 3₂, that is, with switching on and switching off the electronic switches 3₁, 3₂. As each switching operation is associated with a loss of energy, power losses associated with the switch-mode operation increase as the switching frequency increases.

An efficiency of the power converter can be defined as a ratio between the output power, which is the power received by the load Z, and the overall input power. The “overall input power” not only includes the input power received at the input 11, 12 but also the power required by the control circuit 6 to drive the electronic switches 3₁, 3₂. The switching losses can be considered widely independent of the output power so that at a given switching frequency the efficiency of the power converter decreases as the output power decreases.

A boost converter such as the boost converter shown in FIG. 1 can be operated in critical conduction mode. In this operation mode, the on-period of the at least one electronic switch in the power converter, such as the first electronic switch 3₁, shown in FIG. 1, is adjusted to be dependent on the output power. After the first switch 3₁ has switched off, a current I_{IN} through the inductor 2 is sensed, and the first electronic switch 3₁ switches on again as this current I_{IN} reaches zero. A time duration between switching on the first electronic switch 3₁ and again switching on the first electronic switch 3₁ decreases as the output power and, therefore, the on-period decreases. Thus, the switching frequency, which is the reciprocal of this time period, increases as the output power decreases. This further deteriorates the efficiency of the power converter as the output power decreases.

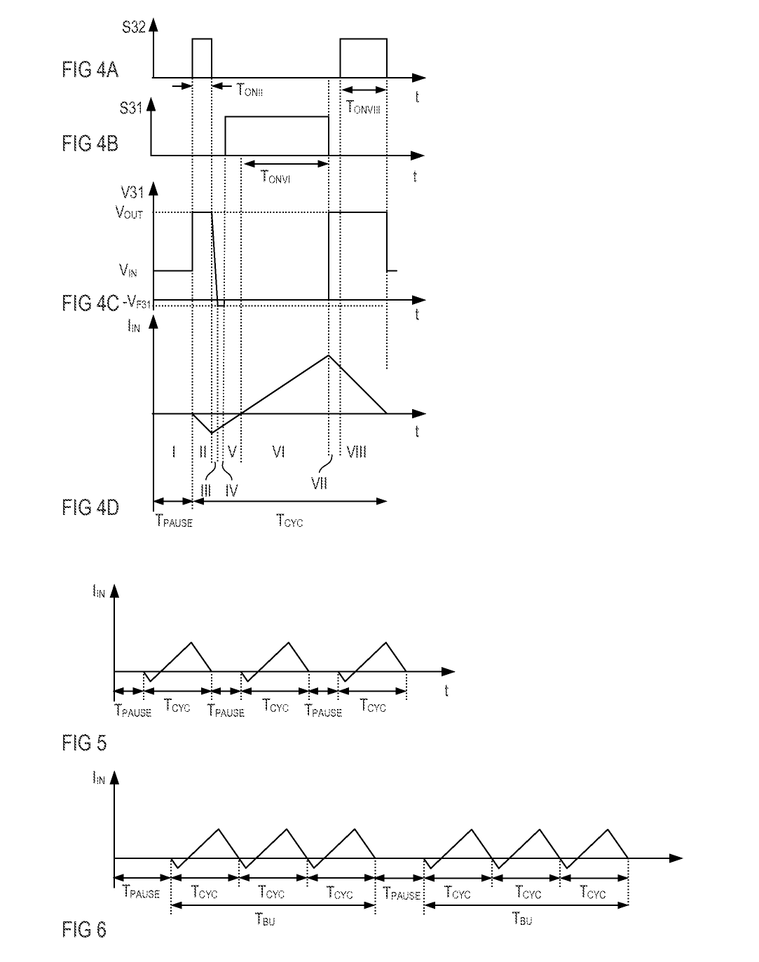

It is therefore desirable to have a high efficiency of the power converter even under low load conditions, which is when the output power of the power converter is significantly below the maximum output power or rated output power of the power converter. One way of operating the power converter to obtain a high efficiency even under low load conditions is explained with reference to FIGS. 4A-4D. These figures show signal waveforms of the first drive signal S31, the second drive signal S32, a voltage V31 across the first electronic switch 31, and the input current I_{IN} (which is the current through the inductor 2). For the purpose of explanation it is assumed that each of the first drive signal S31 and the second drive signal S32 can have a first signal level that switches on the respective switch, or a second signal level that switches off the respective switch. The first level will be referred to as on-level, and the second level will be referred to as off-level in the following. Just for the purpose of explanation, in the signal diagrams shown in FIGS. 4A-4B, the on-level is a high signal level, and the off-level is a low signal level. Operating the power converter in accordance with the drive scheme illustrated in FIGS. 4A-4D includes eight timely successive phases (time intervals) I-VIII, which are explained below.

In a first phase I, each of the first drive signal S31 and the second drive signal S32 has the off-level so that each of the first switch 3₁ and the second switch 3₂ is switched off (is in the off-state). Furthermore, the input current I_{IN} zero in the first phase I. In the first phase I, a voltage V31 across the first electronic switch 3₁ substantially equals the input voltage V_{IN}, and a voltage V32 across the second electronic switch 3₂ substantially equals the output voltage V_{OUT} minus the input voltage V_{IN} (V_{OUT}−V_{IN}). The latter is based on the assumption that before the power converter entered the drive scheme shown in FIGS. 4A-4D it was working in an operation mode, in which the output capacitor 4 has been charged.

In a second phase II succeeding the first phase I, the second drive signal S32 switches on the second electronic switch 3₂ for an on-period T_{ONII}, while the first electronic switch 3₁ is still in the off-state. In this second phase II, a current I_{IN} flows through the inductor 2 in a direction opposite the direction indicated in FIG. 1. An input current I_{IN} flowing in this direction will be referred to as negative input current I_{IN} in the following. Over this on-period T_{ONII} of the second electronic switch 3₂ the current level of the input current I_{IN} increases. This increase is substantially proportional to the voltage difference V_{OUT}−V_{IN} and proportional to the reciprocal of an inductance on the inductor 2. That is,

$$\frac{d {I}_{IN}}{d t} = - \frac{{V}_{OUT} - {V}_{IN}}{L} , \qquad ( 1 )$$

where V_{OUT} denotes the voltage level of the output voltage, V_{IN} denotes the voltage level of the input voltage, and L denotes the inductance of the inductor 2.

In a third phase III succeeding the second phase II, both the first electronic switch 3₁ and the second electronic switch 3₂ are in the off-state. By virtue of the energy that has been magnetically stored in the inductor 2 during the second phase, the inductor 2 causes the input current I_{IN} to continue to flow in the third phase III. In the third phase III, the current I_{IN} causes a parasitic capacitance C31 of the first electronic switch 3₁ to be discharged. This parasitic capacitance has been charged in the second phase such that in the second phase II the voltage V31 across the first electronic switch 3₁ substantially equals the output voltage V_{OUT}. In the third phase III, the input current I_{IN} discharges the parasitic capacitance C31 of the first electronic switch 3₁. At the end of the third phase III, the parasitic capacitance C31 has been discharged so that the voltage V31 substantially drops to zero. More precisely, the voltage V31 drops to the inverted forward voltage of the rectifier element 3₃ connected in parallel with the first electronic switch 3₁. This is because the rectifier element 3₃, in a fourth phase IV succeeding the third phase III, takes over the negative input current I_{IN} after the parasitic capacitance C31 has been discharged. The voltage V31 then equals −V_{F31}, where V_{F31} is the forward voltage of the rectifier element 3₃. For example, the rectifier element 3₃ is a diode.

A fifth phase V starts when the first electronic switch 3₁ switches on. The first electronic switch 3₁ switches on when the input current I_{IN} is still negative. In order to keep conduction losses low, it may be desirable to switch on the first electronic switch 3₁ as soon as possible after the parasitic capacitance C31 has been discharged and the negative input current I_{IN} started to flow through the rectifier element 3₃. In the fifth phase, the voltage V31 is given by an on-resistance of the first electronic switch multiplied with the current level of the input current I_{IN}. The “on-resistance” of the first electronic switch 3₁ is the electrical resistance of the first electronic switch 3₁ in the on-state and is mainly dependent on the type and the specific design of the first electronic switch 3₁. According to one example, the magnitude of this voltage V31 is lower than the forward voltage V_{F31}. Just for the purpose of illustration, this voltage is drawn to be zero in the fifth phase V. Switching on the first electronic switch 3₁ when the parasitic capacitance C31 has been discharged makes it possible to switch on the first electronic switch 3₁ when the voltage V31 across the first electronic switch 3₁ is substantially zero. This helps to reduce switching losses and is known as zero voltage switching (ZVS).

During the fifth phase, the inductor 2 completely demagnetizes and the current I_{IN} decreases to zero. After the inductor 2 has been completely demagnetized, in a sixth phase VI, the input voltage V_{IN} causes the input current I_{IN} to flow in the direction as shown in FIG. 1, and causes the inductor 2 to magnetize but with a polarization opposite the polarization in the second phase II. The time derivative of the current I_{IN} in the sixth phase is substantially given by

$$\frac{d {I}_{IN}}{d t} = \frac{{V}_{IN}}{L} , \qquad ( 2 )$$

where L is the inductance of the inductor 2. Essentially, the output voltage V_{OUT} is controlled by controlling the duration of this sixth phase VI. The duration of this sixth phase is referred to as on-time of the first switch 3₁ in the following. According to one example, the duration of this on-time is controlled by the error signal S_{ERR}.

A seventh phase VII begins when the first electronic switch 3₁ switches off and the second electronic switch 3₂ is still in the off-state. In the seventh phase VII, the inductor 2 causes the input current I_{IN} to continue to flow. The rectifier element 3₄ connected in parallel with the second electronic switch 3₂ takes over the input current I_{IN} in the seventh phase VII. In this phase, a part of the energy that was magnetically stored in the inductor 2 during the sixth phase VI is transferred via the rectifier element 3₄ connected in parallel with the second switch 3² to the output 13, 14. This energy transfer continuous in an eighth phase VIII when the second electronic switch 3₂ switches on. Switching on the second electronic switch 3₂ causes the rectifier element 3₄ to be bypassed and helps to reduce conduction losses during the energy transfer from the inductor 2 to the output 13, 14. The eighth phase VIII ends, when the energy from the inductor 2 has been completely transferred to the output 13, 14, that is, when the input current I_{IN} has decreased to zero. The time derivative of the input current I_{IN} in the eighth phase VIII is substantially given by equation (1). In order to detect when the inductor 2 has been demagnetized at the end of the eighth period VIII the control circuit may monitor an auxiliary voltage V_{AUX} across an auxiliary winding 8 (shown in FIG. 1) magnetically coupled with the inductor.

In the drive scheme explained with reference to FIGS. 4A-4D, switching losses in the first electronic switch 3₁ are low as the first electronic switch 3₁ performs zero voltage switching (ZVS). Furthermore, by introducing the first phase I, the switching frequency can be adjusted. In particular, the switching frequency can be adjusted to be below a predefined frequency threshold. In the following, a time period between the beginning of the second phase II and the end of the eighth phase VIII will be referred to as cycle period T_{CYC}, and the first phase I will be referred to as pause period T_{PAUSE}.

In the drive scheme shown in FIGS. 4A-4D, the signal waveform of the input current I_{IN} in phases II-V and in phases VI-VIII is substantially triangular, while in the first phase I the input current I_{IN} is substantially zero. The operation mode shown in FIGS. 4A-4D may therefore be referred to as intermittent triangular current mode (ITCM) or burst TCM.

The drive scheme shown in FIGS. 4A-4C can be used in several different ways to drive (control) the power converter in the light load mode or partial load mode (LLM). Some examples are explained with reference to FIGS. 5, 6, and 7A-7C below. These figures each show a timing diagram of the input current I_{IN}.

Referring to FIG. 5, driving the power converter in the LLM includes driving the power converter in a plurality of drive cycles of the type explained with reference to FIGS. 4A-4D above. Each of these drive cycles includes drive phases II-VIII, and the individual drive cycles are separated by pause periods T_{PAUSE}. Referring to FIGS. 4A-4C, energy (input power) is received from the input 11, 12 in the sixth phase VI. In the method shown in FIG. 5, the average input power can be adjusted in several ways. The “average input power” is the energy received from the input 11, 12 in the sixth phase V divided by a time duration including the duration T_{CYC} of the drive cycle plus the duration T_{PAUSE} of the pause period preceding the drive cycle. The average input power can be adjusted by varying the duration T_{PAUSE} of the pause period and/or the duration T_{ONVI} of the sixth phase VI. For example, at a given voltage level of the input voltage V_{IN} and a given duration of the sixth phase VI the average input power decreases as the duration T_{PAUSE} of the pause period increases.

According to one example, driving the power converter in accordance with the drive scheme shown in FIGS. 4A-4D includes, in each drive cycle, selecting the time period T_{ONVI} of the sixth phase VI to be substantially constant, and to vary the duration of the pause period T_{PAUSE}. According to another example, driving the power converter in accordance with the drive scheme shown in FIG. 4 includes varying the duration of the sixth phase VI, while the duration T_{PAUSE} of the pause period is substantially constant. According to another example, both, the duration T_{PAUSE} of the pause period and the duration of the fifth phase V are varied in order to vary the average input power.

Referring to FIG. 6, driving the power converter in accordance with the drive scheme shown in FIGS. 3A-3C includes a plurality of drive cycles, each including phases II to VIII following one pause period I. In this method, the average input power is given by the energy received from the input 11, 12 in the plurality of drive cycles divided by the duration of the plurality of drive cycles plus the duration of the pause period preceding the plurality of drive cycles. In the following, the time period with the plurality of drive cycles will be referred to as burst period, T_{BU} denotes the duration of the burst period. In other words, the average input power in this method can be calculated by dividing the energy received in the plurality of drive cycles divided by a time duration equal the pause period T_{PAUSE} plus the burst period T_{BU}. In this method, the average input power can be varied by varying the duration of the pause period T_{PAUSE}, by varying the number of drive cycles following one pause period, and by varying the durations T_{ONVI} of the sixth phases of the individual drive cycles. According to one example, the number of drive cycles following one pause period is fixed, the duration of the fifth phases of the individual drive cycles is fixed, and the duration of the pause period T_{PAUSE} is varied. According to another example, the duration of T_{PAUSE} of the pause period is fixed, the durations of the sixth phases of the individual drive cycles is fixed, but the number of drive cycles succeeding one pause period is varied.

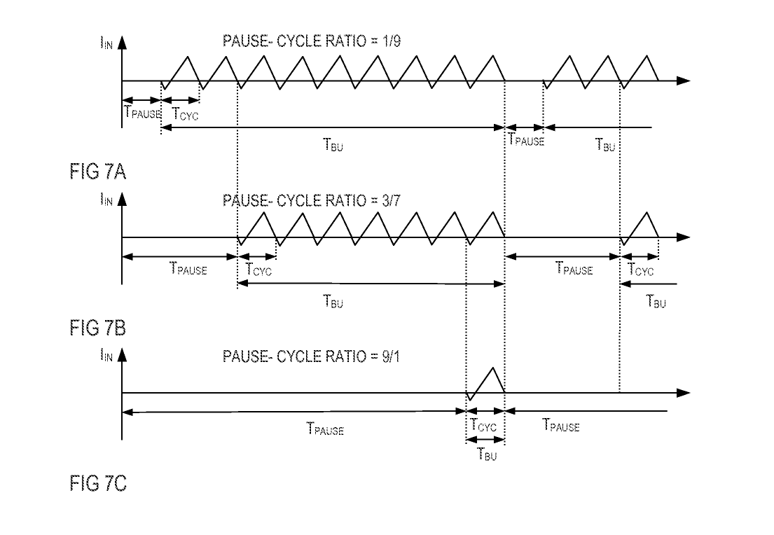

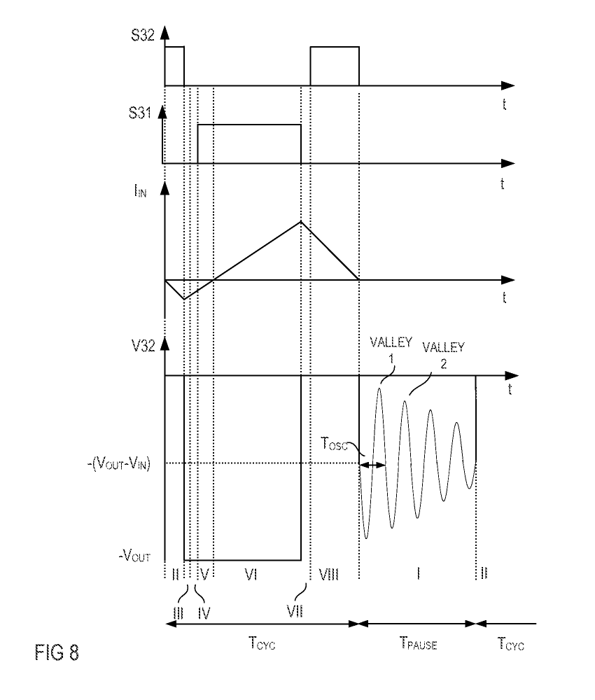

FIGS. 7A-7C illustrate a method which is a modification of the method shown in FIG. 6. In this method, the duration of the sixth phase VI in each drive cycle is fixed, but the number of drive cycles following one pause period and the duration of the pause period are varied such that the overall duration of one pause period T_{PAUSE} plus the duration of the plurality of drive cycles succeeding the pause period is substantially fixed. In other words, the duration of the pause period T_{PAUSE} is a multiple of a duration of one drive cycle. FIGS. 7A-7C show a method in which the overall duration is ten times the duration of one drive cycle. In this method, the duration of the pause period T_{PAUSE} can vary between the duration of one drive cycle and the duration of nine drive cycles, whereas between one and nine drive cycles may succeed the pause period. FIG. 6A shows an example where nine drive cycles follow one pause period, FIG. 6B shows an example where seven drive cycles follow one pause period, and FIG. 6C shows an example where one drive cycle follows one pause period.

One example of a method for adjusting a duration of the pause period is explained with reference to FIG. 8, which shows timing diagrams of the first and second drive signals S31, S32, the input current I_{IN}, and the voltage V32 across the second electronic switch 3₂. Referring to FIG. 8, the voltage V32 essentially is zero in phase II, essentially equals −V_{OUT} in phases III-VI, and is essentially zero in phases VII and VIII. After phase VIII, in a steady state, the electrical potential at the circuit node common to the first electronic switch 3₁ and the second electronic switch 3₂ equals the input voltage V_{IN} so that the voltage V32 across the second electronic switch 3₂ equals V_{IN}−V_{OUT}. This voltage V32 is negative if V_{IN}<V_{OUT}. However, immediately after the end of phase VIII and the beginning of the first phase I, that is, immediately after switching off the second electronic switch 3₂ the electrical potential at circuit is not equal V_{IN} but oscillates around V_{IN}. An amplitude of this oscillation is essentially V_{OUT}−V_{IN} in the beginning and then decreases. This oscillating electrical potential at the circuit node 15 results in an oscillation of the voltage V32 across the second electronic switch 32. In particular, the voltage V32 oscillates around V_{OUT}−V_{IN}, which is the voltage V32 has in the steady state. Periodically, the voltage V32 includes local minima or valleys. The oscillation is due to parasitic capacitances, such as capacitances C31, C32, and inductances. Those capacitances may include the inductor 2 and parasitic inductances, such as line inductances.

According to one example, the control circuit 6 is configured to monitor the voltage V32 across the second electronic switch in the pause period T_{PAUSE} and two switch on the second electronic switch 3₂ at the end of the pause period T_{PAUSE} (the first phase I) and the beginning of the second phase II when there is a valley of the voltage V32 across the second electronic switch 3₂. In this case, the duration of the pause period T_{PAUSE} is selected from several time periods, wherein each of these time periods is given by a time difference between the timely position of one valley and the beginning of the pause period. A frequency of this oscillation can be considered to be essentially constant. In this case, the duration of the pause period T_{PAUSE} is a multiple of one period T_{OSC} (see, FIG. 8) of the oscillation.

For the purpose of explanation it is assumed that the valleys have an order number, wherein the order number reflects the timely position of the respective valley after the beginning of the pause period T_{PAUSE}. For example, a first valley occurring after the beginning of the pause period T_{PAUSE} has order number “1”, a second valley has order number “2”, etc.

According to one example, the control circuit 6 is configured to monitor an output power P_{OUT} and to select the duration of the pause period T_{PAUSE} dependent on the level of the output power P_{OUT}. In particular, the control circuit 6 is configured to select the order number of the valley at which the pause period ends dependent on the level of the output power P_{OUT}. In the following, the valley at which the pause period ends will be referred to as “the valley that terminates the pause period T_{PAUSE}” The output power reflects the power consumption of the load, which may vary. The output power P_{OUT} is given by the output current I_{OUT} multiplied with the output voltage V_{OUT}. In order to monitor the power consumption, the control circuit 6 may calculate the output power based on the output current I_{OUT} and the output voltage V_{OUT}. Alternatively, assuming that the output voltage V_{OUT} is controlled to be essentially constant, the control circuit 6 may only monitor the output current I_{OUT} in order to monitor the output power P_{OUT}.

FIG. 9 illustrates one example of how the control circuit 6 may adjust the pause period T_{PAUSE} dependent on the output power P_{OUT}. FIG. 9 shows the order number of the valley that terminates the pause period dependent on the output power P_{OUT}, wherein the output power decreases from left to right in the diagram. In this example, valley number “0” means that no pause period is introduced (or that the duration of the pause period T_{PAUSE} or phase I is zero) before the beginning of the second phase II. An operation mode with no pause period is also known as triangular current mode (TCM). Operating a boost converter in TCM is known and, for example, is disclosed in U.S. Pat. No. 8,026,704 B2 to which reference is made.

In the example shown in FIG. 9, the control circuit begins to introduce a pause period, that is, to begin the ITCM when the output power falls below a predefined threshold P_{OUT-TH}. Furthermore, there are several power ranges between the threshold P_{OUT-TH} and a minimum output power P_{OUT-MIN}, wherein one valley number is associated with each of these power ranges. The valley numbers are associated with these power ranges such that the closer one power range is to P_{OUT-MIN} the longer is the associated duration of the pause period. For example, the closer one power range is to P_{OUT-MIN} the higher is the associated valley number. According to one example, the control circuit 6 considers a hysteresis in the assignment of one power range to a valley number in order to prevent a frequent change between two valley numbers when the output power P_{OUT} is close to a border between two neighboring power ranges. Such hysteresis curves are shown in dashed lines in FIG. 9.

According to one example, the threshold P_{OUT-TH} is 50% or less of a maximum output power P_{OUT-MAX}, wherein the maximum output power P_{OUT-MAX} is the maximum power the power converter can supply. According to another example, the complete power range from P_{OUT-MAX} to P_{OUT-MIN} is divided into ranges and each range is associated with a valley number, wherein in the highest of these ranges no pause period may be introduced.

Selecting the valley that terminates the pause period T_{PAUSE} dependent on the output power P_{OUT}, as shown in FIG. 9, may be used in a drive scheme as shown in FIG. 5, where a pause period T_{PAUSE} precedes each cycle period T_{CYC}, or in a drive scheme as shown in FIG. 6, where a pause period precedes a sequence of several cycle periods T_{CYC}. The duration of the second phase II may be fixed in this method, and the output voltage V_{OUT} can be controlled as explained before. That is, the output voltage V_{OUT} is controlled by adjusting the on-time of the first switch 3₁ dependent on the error signal S_{ERR}. At first, when the control circuit 6 based on the diagram shown in FIG. 9 introduces the pause period T_{PAUSE} or prolongs the pause period T_{PAUSE} and the on-time of the first switch 3₁ remains unchanged, the output voltage V_{OUT} may slightly decrease. This is because the energy received from the input 11, 12 during the on-time of the first switch 3₁ remains unchanged, at first, and the duration of the pause period T_{PAUSE} plus the duration of the at least one cycle period T_{CYC} increases so that the average input power decreases. A decrease of the output power, however causes a change of the error signal S_{ERR} (an increase or a decrease, dependent on how the error signal S_{ERR} is generated) such that after prolonging the pause period T_{PAUSE} the on-time of the first switch 3₁ increases in order to keep the output voltage V_{OUT} essentially constant. In this way, by prolonging the pause period T_{PAUSE} the switching frequency is not only reduced by the longer pause period T_{PAUSE} but also by the longer on-time of the first switch 3₁ and, resulting from the longer on-time of the first switch 3₁ (phase VI), a longer demagnetization time (phases VII and VIII).

By prolonging the pause period T_{PAUSE}, the switching frequency f_{SW} can be adjusted and, in particular, limited. For example, the switching frequency is the reciprocal of the pause period T_{PAUSE} plus the cycle period T_{CYC} (f_{SW}=1/(T_{PAUSE}+T_{CYC})). In the drive scheme shown in FIG. 6, there is a further switching frequency given by the reciprocal of the cycle period T_{CYC}. By prolonging the pause period T_{PAUSE}, at a given power consumption of the load, each of the cycle periods becomes longer for the reasons explained above so that a decrease of the switching frequency also results in a decrease of this further switching frequency.

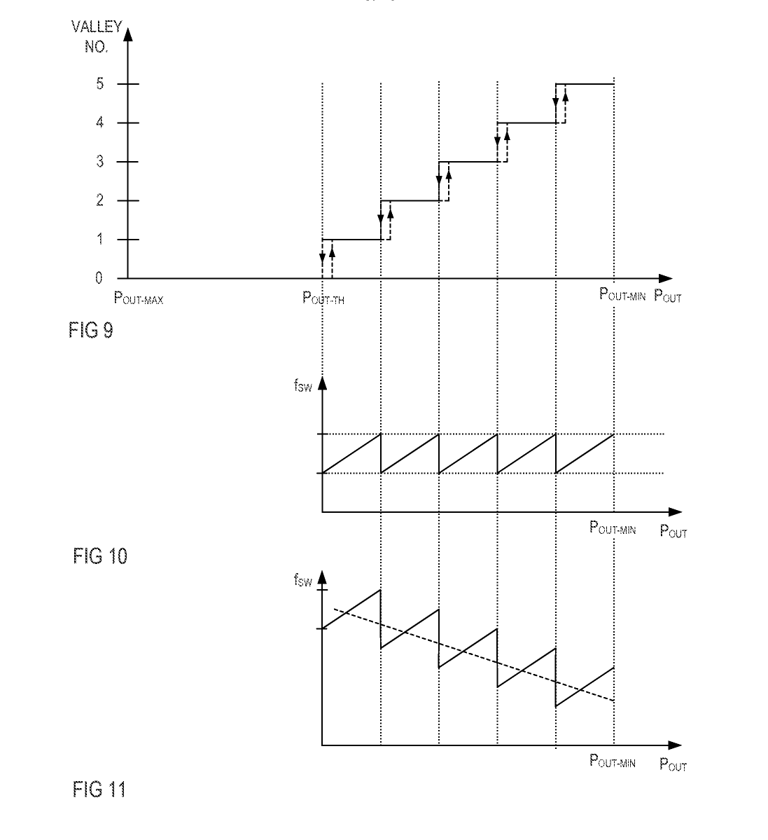

FIG. 10 schematically illustrates the switching frequency in the power range between P_{OUT-TH} and the minimum power in the method shown in FIG. 9. Referring to FIG. 9, and as explained above, prolonging the duration of the pause period T_{PAUSE} results in a decrease of the switching frequency f_{SW} (and the further switching frequency 1/T_{CYC}, if there is any). As the output power decreases, the switching frequency increases, because the on-time of the first switch 3₁ (phase VI) and the demagnetization time (phases VII and VIII) become shorter. Referring to FIG. 10, the power ranges can be selected such that the switching frequency, in each power range, is essentially in the same frequency range. This, however, is just an example.

According to another example, shown in FIG. 11, the power ranges associated with the valley numbers can even be selected such that the average switching frequency decreases as the output power P_{OUT} decreases. The average switching frequency is illustrated by a dashed line in FIG. 11. In this example, the switching frequency at a lower end of each power range falls below the switching frequency at an upper end of the respective power range. Such a behavior of the switching frequency f_{SW} as a function of the output power P_{OUT} may help to increase the efficiency at light load and flattens out the efficiency curve across the entire load range and output power range P_{OUT}, respectively.

In the example shown in FIG. 9, the valley number increases in steps of 1 as the output power P_{OUT} decreases. This, however, is only an example. According to another example the valley number increases in steps of n, with n being an integer higher than 1, when the output power decreases. The method shown in FIG. 11 may employ an increase of the valley number in steps of n.

In the methods explained with reference to FIGS. 9-11, each of the power ranges between P_{OUT-TH} and P_{OUT-MIN} is associated with a duration of the pause period. In these examples, each of these durations is a multiple of the period T_{OSC} of the parasitic oscillation and, more specifically, is given by this period T_{OSC} multiplied with the valley number associated with the respective power range. The methods explained with reference to FIGS. 9-11 is not restricted to switch on in valleys, that is, the pause durations associated with the power ranges are not restricted to be multiples of the oscillation period T_{OSC}. Instead, other time durations may be associated with the individual power ranges as well.

According to another example, the control circuit is configured to monitor the switching frequency f_{SW} and is configured to prolong the pause period T_{PAUSE} each time the switching frequency f_{SW} reaches a predefined frequency threshold. Prolonging the pause period T_{PAUSE} may include increasing the valley number by 1 or n.

As explained above, in the pause period (phase I), the electrical potential at circuit node 15 oscillates around the input voltage, with the maximum amplitude of this oscillation being given by V_{OUT}−V_{IN}, which is the voltage across the second electronic switch in the steady state. By virtue of the rectifier element 5₁ connected in parallel with the first electronic switch 3₁, the electrical potential at the circuit node 15 cannot decrease below zero and, more precisely, −VF₅₁, wherein −VF₅₁ is the negative forward voltage of the rectifier element 3₁. The electrical potential at the circuit node 15 may reach zero if V_{IN}<V_{OUT}−V_{IN}, that is, if V_{IN}<V_{OUT}/2. The electrical potential at the circuit node 15 equals the voltage V31 across the first electronic switch 3₁. If there are time instances in the pause period T_{PAUSE} in which this voltage V31 becomes zero, ZVS conditions for switching the first electronic switch 3₁ can be achieved without pre-magnetizing the inductor 2. Thus, according to one example, the control circuit is configured to compare a voltage level of the input voltage V_{IN} with a voltage level of the output voltage V_{OUT} and to use the switching scheme shown in FIG. 4 only if the voltage level of the input voltage V_{IN} is greater than 0.5 times the voltage level of the output voltage V_{oUT} (V_{IN}>V_{OUT}/2). Under these conditions, the voltage V31 across the first electronic switch 3₁ cannot decrease to zero in the pause period T_{PAUSE} so that ZVS conditions can only be obtained by pre-magnetizing the inductor 2. If V_{IN}<V_{OUT}/2, phases II-V may be omitted so that the first electronic switch 3₁ is switched on (in phase VI) directly after the pause period T_{PAUSE}.

FIG. 12 schematically illustrates the drive scheme, by showing the input current I_{IN} in a pause period (phase I) and a succeeding cycle period. As can be seen, if V_{IN}<V_{OUT}/2, phases II-V are omitted in the cycle period succeeding the pause period so that the sixth phase VI directly succeeds the first phase I. According to one example, phases II-V are only omitted in the cycle period directly succeeding the pause period (phase I). Thus, in a drive scheme as shown in FIG. 5, which includes a pause period T_{PAUSE} before each cycle period T_{CYCLE}, phases II-V are omitted in each cycle period T_{CYCLE} as long as the instantaneous level of the input voltage V_{IN} is below 50% of the level of the output voltage V_{OUT} (V_{IN}<V_{OUT}/2). In a drive scheme as shown in FIGS. 6 and 7A-7C, however, in which several successive cycle periods T_{CYCLE} follow one pause period T_{PAUSE}, phases II-V are omitted in that drive cycle that directly succeeds the pause period T_{PAUSE} while there are phases II-V in each of the other drive cycles that do not directly succeed the pause period, that is, that directly succeed a previous drive cycle.

Using the drive scheme shown to the left in FIG. 12, the output voltage V_{OUT} can be controlled in the same way as explained above. Furthermore, the same type of burst cycles can be used, such as the type shown in FIG. 5 or the type shown in FIG. 6. Furthermore, the frequency can be controlled essentially in the same way as explained above, with the difference that those times where the voltage across the first switch 3₁ becomes zero may define the end of the pause period T_{PAUSE}, instead of valleys of the voltage V32.

According to one example, the input voltage V_{IN} is a direct voltage. According to another example, the input voltage V_{IN} is a rectified sinusoidal voltage. Such rectified sinusoidal voltage can be obtained from a sinusoidal grid voltage V_{AC} by using a bridge rectifier 10. Such bridge rectifier is shown in dashed lines in FIG. 1.

According to one example, the input voltage V_{IN} is a rectified sinusoidal voltage and the power converter has a PFC (Power Factor Correction) capability. In this case, the power converter is configured to not only control a voltage level of the output voltage V_{OUT}, but also a waveform of the input current I_{IN} Controlling the waveform of the input current I_{IN} may include controlling the waveform to be substantially in phase with the input voltage V_{IN}.

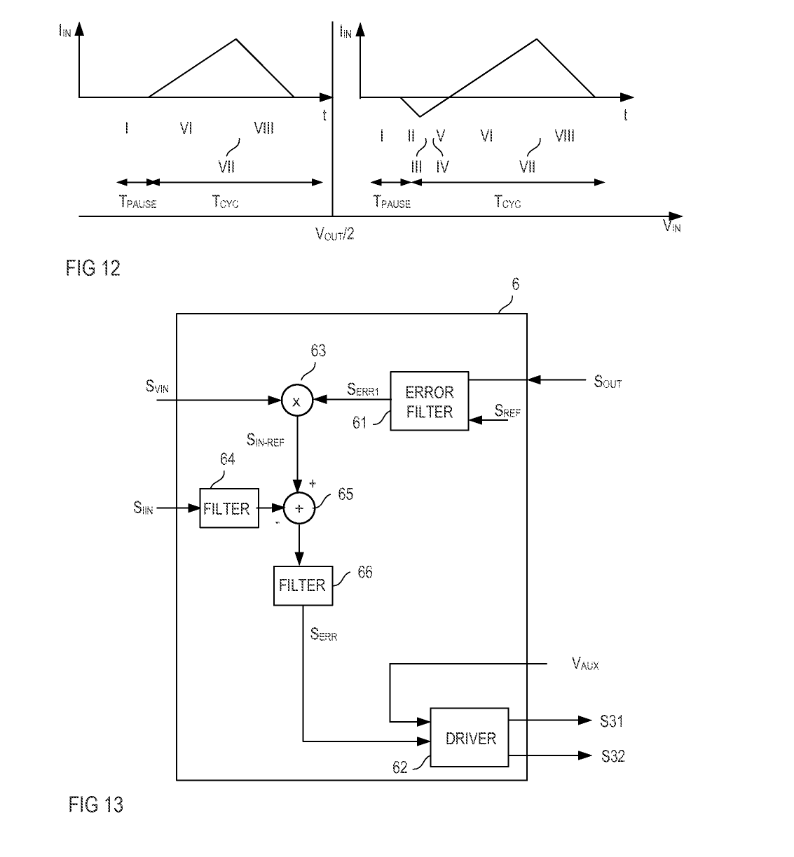

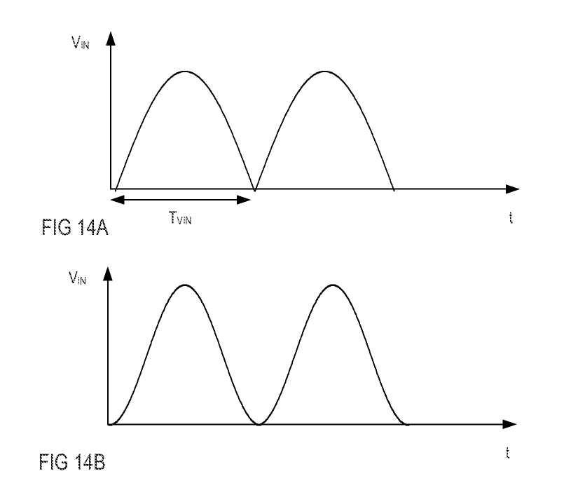

One example of a control circuit 6 that is configured to generate the error signal S_{ERR} such that both the voltage level of the output voltage and the waveform of the input current I_{IN} is controlled is shown in FIG. 13. This control circuit 6 is based on the control circuit 6 shown in FIG. 1 and includes a first error filter 61 which receives the signal S_{OUT} representing the (measured) voltage level of the output voltage V_{OUT} and a reference signal S_{REF}, representing the desired voltage level of the output voltage V_{OUT}. This error filter 61 may be implemented as explained with reference to FIG. 1 herein above. At an output of this first error filter a first error signal S_{ERR1} is available. A first multiplier 63 multiplies the first error signal with an input voltage signal S_{VIN}, which represents the input voltage V_{IN}. Based on this multiplication the multiplier outputs an input current reference signal S_{IN-REF} which defines the desired input current. If for example, the input voltage V_{IN} is a rectified sinusoidal voltage then the current reference signal is a sinusoidal signal with a phase and frequency defined by the input voltage V_{IN} and an amplitude defined by the first error signal S_{ERR1}. A subtractor 65 subtracts a filtered input current signal S_{IIN} from the input current reference signal S_{IN-REF}. The input current signal S_{IIN} represents the input current I_{IN} and is filtered by a filter 64. This filter may have a low-pass characteristic. Another filter 66 receives an output signal of the subtractor 65 and provides the error signal S_{ERR} received by the driver. This filter 66 may have one of a P, PI, and a PID characteristic.

The control circuit shown in FIG. 13 includes two control loops, a first control loop for controlling the output voltage V_{OUT}, and a second control loop for controlling the input current I_{IN}. For example, if the input voltage V_{IN} is a periodic rectified sinusoidal voltage with a frequency of 100 Hz then the input current reference signal S_{IN-REF} is a periodic signal with a frequency of 100 Hz. In order for the control circuit to be able to control the input current such that it follows the input current reference signal S_{IN-REF}, the switching frequency f_{SW} is significantly higher than the frequency of the reference signal. For example, the switching frequency is at least 10 kHz.

FIGS. 14A and 14B illustrate timing diagrams of the input voltage V_{IN} and the input power P_{IN} if the power converter receives a rectified sinusoidal input voltage V_{IN} and controls the input current I_{IN} to be in phase with the input voltage V_{IN}. As can be seen, the input power P_{IN}, which is the input voltage V_{IN} multiplied with the input current I_{IN}, has a sine square waveform, so that the input power periodically varies between a minimum such as zero and a maximum. The output capacitor shown in FIG. 1 makes it possible for the load to draw a substantially constant output power P_{OUT} although the input power is varying.

The varying input current I_{IN} in connection with the varying input power P_{IN} causes significant variations of the switching frequency f_{SW} over each period of the input voltage V_{IN}, wherein a range over which the frequency varies is further dependent on the output power P_{OUT}.

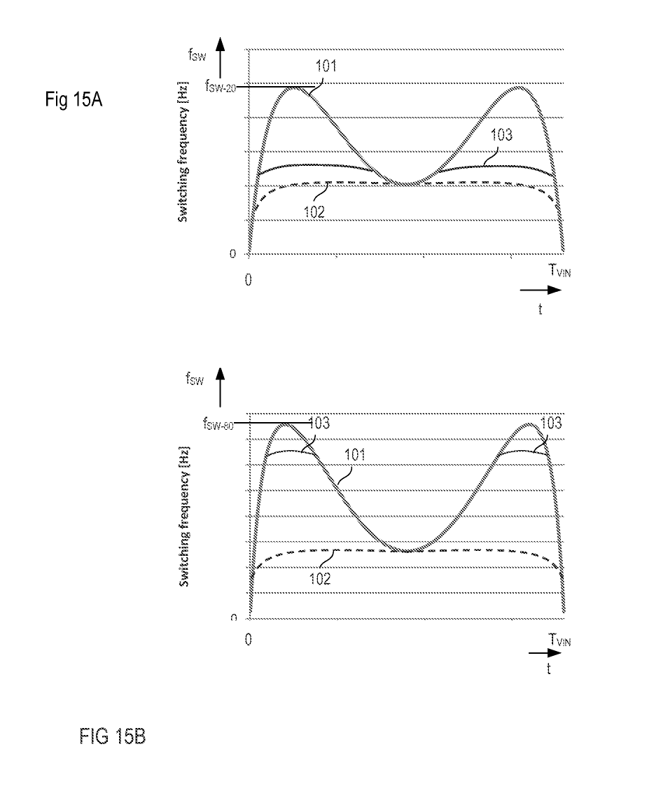

In each of FIGS. 15A and 15B a diagram 101 illustrates a variation of the switching frequency at a given output power over one period of the input voltage V_{IN} in a conventional method, that is, a method that does not employ pause periods. The input voltage is an input voltage of the type shown in FIG. 14A. FIGS. 15A and 15B show different load scenarios. In FIG. 15A, an output power P_{OUT} is 20% of a maximum output power of the power converter, while in FIG. 15B the output power is 80% of the maximum output power. FIGS. 15A and 15B are not to scale. That is, a maximum switching frequency f_{SW-20} in the scenario shown in FIG. 15A can be higher than the maximum switching frequency f_{SW-80} in the scenario shown in FIG. 15B. For example f_{SW-20}=250 kHz and f_{SW-20}=150 kHz. Equivalently, a minimum switching frequency f_{SW-20} in the scenario shown in FIG. 15A can be higher than the minimum switching frequency f_{SW-80} in the scenario shown in FIG. 15B. Nevertheless, by employing the switching schemes explained with reference to FIG. 12 those variations can be reduced as shown by diagrams 102 and 103 in FIGS. 15A and 15B. In both examples, the switching frequency is limited, wherein the limit is different in the two examples. The frequency may be limited by the method explained with reference to FIG. 9, with the difference that the input power P_{IN} is divided in power ranges and a duration of the pause period T_{PAUSE} is made dependent on the instantaneous input power. According to another example, the control circuit monitors the switching frequency and prolongs the pause period each time the frequency reaches the predefined frequency limit. In each case, a pause period may be inserted before each cycle period (as shown in FIG. 5) or before a sequence of cycle periods (as shown in FIG. 6). The reduced switching frequencies illustrated by curves 102 and 103 in FIGS. 15A and 15B represent the switching frequency given by f_{SW}=1/(T_{PAUSE}+T_{CYC}), although there may be another higher switching frequency given by 1/T_{CYC} if a drive scheme as shown in FIG. 6 is employed. In each case, the presence of phases II-V in the cycle period directly succeeding the pause period can be made dependent on the instantaneous level of the input voltage as explained with reference to FIG. 12.

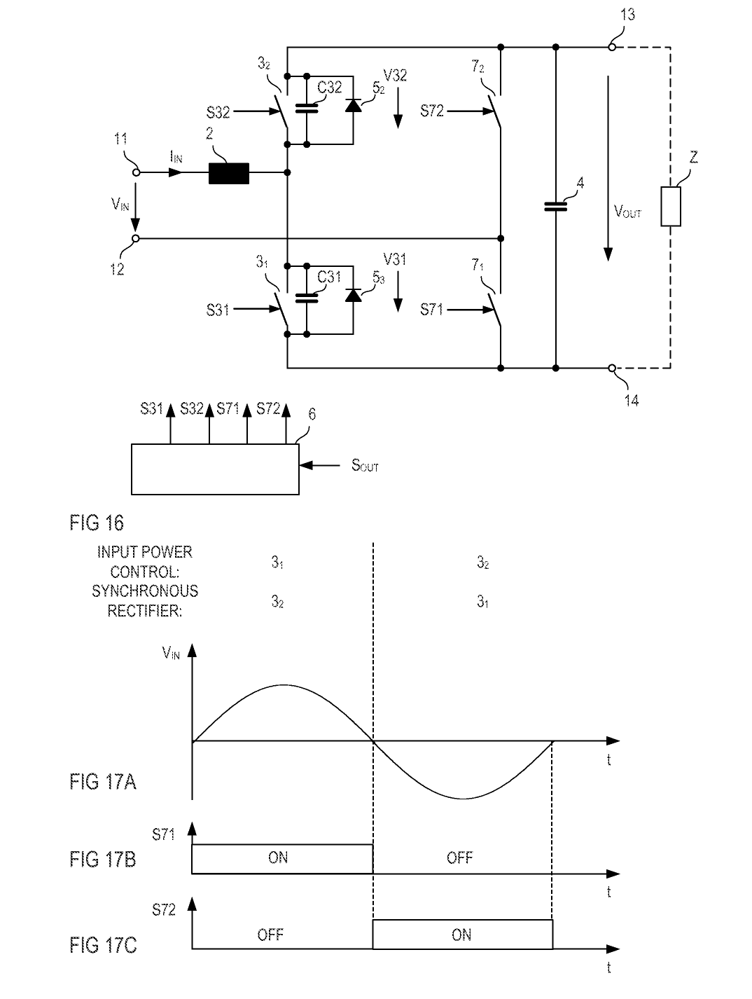

FIG. 16 shows a power converter according to another topology. The power converter according to this topology is configured to receive an alternating voltage such as, for example, a sinusoidal voltage as the input voltage V_{IN}. This power converter is different from the power converter shown in FIG. 1 in that it additionally includes a third switch 7₁ and a fourth switch 7₂ connected in series between the output nodes 13, 14. A circuit node common to the third switch 7₁ and the fourth switch 7₂ is connected to the second input node 12, wherein the third switch 7₁ is connected between the second input node 12 and the first output node 14 and the fourth switch 7₂ is connected between the second input node 12 and the first output node 13. A circuit node common to the first switch 3₁ and the second switch 3₂ is connected to the inductor 2, as already explained with reference to FIG. 1. The control circuit 5 generates a third drive signal S71 that drives the third switch 7₁, and a fourth drive signal S72 that drives the fourth switch 7₂.

One way of operation of the power converter shown in FIG. 16 is explained with reference to FIGS. 17A-17C below. FIG. 17A shows the signal waveform of a sinusoidal input voltage V_{IN} during one period of the input voltage V_{IN}, FIG. 17B shows a signal waveform of the third drive signal S71, and FIG. 17C shows a signal waveform of the fourth drive signal S72. Just for the purpose of explanation it is assumed that a high signal level of the third drive signal S41 or the fourth drive signal S42 switches on the respective switch 4₁, 4₂ and that a low signal level switches off the respective switch.

Referring to FIG. 17A, the input voltage V_{IN} in one period includes a positive halfwave, which is when the signal level of the input voltage V_{IN} is positive, and a negative halfwave, which is when the signal level is negative. In the positive halfwave, the control circuit 5 switches on the third switch 7₁ and switches off the fourth switch 7₂. In this positive halfwave, the power converter circuit operates in the same way as the power converter circuit shown in FIG. 1. That is, the control circuit 5 controls the average input power by a switched-mode operation of the first electronic switch 3₁. The second electronic switch 3₂ operates as a synchronous rectifier in this operation mode.

In the second halfwave, the control circuit 5 switches off the third switch 7₁ and switches on the fourth switch 7₂. In this operation mode, the roles of the first electronic switch 3₁ and the second electronic switch 3₂ in the power converter are changed as compared to their roles in the positive halfwave. That is, in this operation mode, the second electronic switch 3₂ serves to control the average input power and the first electronic switch 3₁ acts as the synchronous rectifier. That is, during the negative half wave, the second electronic switch 3₂ is operated in the same way as the first electronic switch 3₁ in the power converter circuit shown in FIG. 1, and the first electronic switch 3₁ is operated in the same way as the second electronic switch 3₂ in the power converter circuit shown in FIG. 1. The third electronic switch 7₁ and the fourth electronic switch 7₂ can be conventional electronic switches such as MOSFETs, IGBTs, JFETs, BJTs, or HEMTs.

Referring to the above, the drive scheme explained with reference to FIGS. 4A-4C is not restricted to be used in a power converter with a boost topology, but may be applied to power converters with other converter topologies as well.

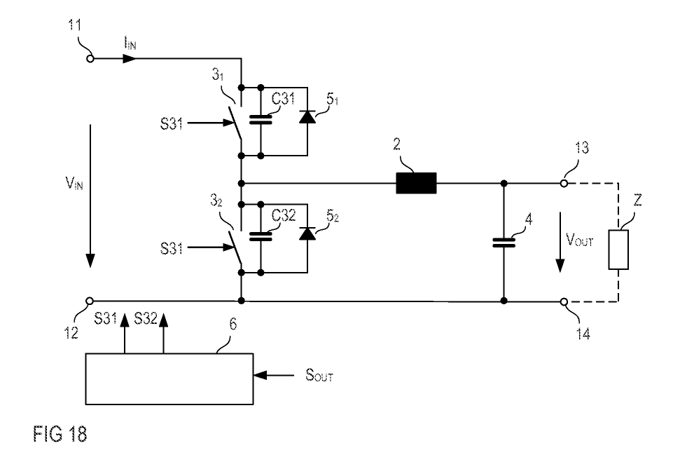

FIG. 18 shows one example of a power converter implemented with a buck topology. In this converter, the first electronic switch 3₁ and the second electronic switch 3₂ are connected in series between the input nodes 11, 12, and the inductor 2 is connected between the first output node 13 and a circuit node common to the first electronic switch 3₁ and the second electronic switch 3₂. In this type of converter, the average input power can be controlled by controlling a switched-mode operation of the first electronic switch 3₁. The second electronic switch 3₂ acts as a synchronous rectifier. The operation mode explained with reference to FIGS. 3A-3C can be used in this type of power converter as well.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

Spatially relative terms such as “under,” “below,” “lower,” “over,” “upper” and the like, are used for ease of description to explain the positioning of one element relative to a second element. These terms are intended to encompass different orientations of the device in addition to different orientations than those depicted in the figures. Further, terms such as “first,” “second” and the like, are also used to describe various elements, regions, sections, etc. and are also not intended to be limiting. Like terms refer to like elements throughout the description. As used herein, the terms “having,” “containing,” “including,” “comprising” and the like are open ended terms that indicate the presence of stated elements or features, but do not preclude additional elements or features. The articles “a,” “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A method, comprising:
in at least one of a plurality of drive cycles of a power converter, pre-magnetizing an inductor connected in series with a first electronic switch, discharging a parasitic capacitance of the first electronic switch using energy stored in the inductor by the pre-magnetizing, and after discharging the parasitic capacitance, switching on for an on-period the first electronic switch; and
before at least one of the plurality of drive cycles of the power converter, maintaining the first electronic switch switched off and the inductor demagnetized in a pause period.

2. The method of claim 1, wherein pre-magnetizing the inductor comprises coupling the inductor to an output of the power converter by a second electronic switch.

3. The method of claim 1, wherein maintaining the first electronic switch switched off and the inductor demagnetized comprises:
maintaining the first electronic switch switched off and the inductor demagnetized before each of the plurality of drive cycles.

4. The method of claim 1, wherein maintaining the first electronic switch switched off and the inductor demagnetized comprises:
maintaining the first electronic switch switched off and the inductor demagnetized before a burst with several successive drive cycles.

5. The method of claim 1, wherein the method further comprises:
receiving an input voltage at an input of the power converter and providing an output voltage at an output of the power converter;
monitoring the input voltage; and
operating the power converter in a first operation mode if an input voltage value of the input voltage is higher than a predefined threshold.

6. The method of claim 5, wherein operating the power converter in the first operation mode comprises in each of the plurality of drive cycles:
pre-magnetizing the inductor;
discharging the parasitic capacitance of the first electronic switch using energy stored in the inductor by the pre-magnetizing; and
after discharging the parasitic capacitance, switching on for an on-period the first electronic switch.

7. The method of claim 5, wherein the predefined threshold is 0.5 times an output voltage value of the output voltage.

8. The method of claim 5, further comprising:
operating the power converter in a second operation mode if the input voltage value is below the predefined threshold.

9. The method of claim 8, wherein operating the power converter in the second operation mode comprises, in a drive cycle directly succeeding the pause period:
switching on for an on-period the first electronic switch at the end of the pause period.

10. The method of claim 8, wherein, in the second operation mode, maintaining the first electronic switch switched off and the inductor demagnetized comprises:
maintaining the first electronic switch switched off and the inductor demagnetized before each of the plurality of drive cycles.

11. The method of claim 8, wherein, in the second operation mode, maintaining the first electronic switch switched off and the inductor demagnetized comprises:
maintaining the first electronic switch switched off and the inductor demagnetized before a burst with several successive drive cycles.

12. The method of claim 2, further comprising:
in the pause period, monitoring a voltage across the second electronic switch and detecting valleys of this voltage; and
switching on the second electronic switch at a time of one valley.

13. The method of claim 1, further comprising:
monitoring an output power of the power converter and adjusting a duration of the pause period based on the output power.

14. The method of claim 11, wherein adjusting a duration of the pause period comprises prolonging a duration of the pause period as the output power decreases.

15. The method of claim 1, further comprising:
monitoring a switching frequency of the power converter and adjusting a duration of the pause period based on the switching frequency.

16. The method of claim 13, wherein adjusting a duration of the pause period comprises prolonging a duration of the pause period as the switching frequency increases.

17. The method of claim 8, further comprising:
monitoring an output power of the power converter and adjusting a duration of the pause period based on the output power, in the second operation mode.

18. The method of claim 17, wherein adjusting a duration of the pause period comprises prolonging a duration of the pause period as the output power decreases.

19. The method of claim 9, further comprising:
monitoring a switching frequency of the power converter and adjusting a duration of the pause period based on the switching frequency, in the second operation mode.

20. The method of claim 19, wherein adjusting a duration of the pause period comprises prolonging a duration of the pause period as the switching frequency increases.

21. The method of claim 1, wherein the power converter comprises a boost topology.

22. The method of claim 1, wherein the power converter comprises a buck topology.

23. A power converter, comprising:
an inductor connected in series with a first electronic switch; and
a control circuit,
wherein the control circuit is configured to control, in at least one of a plurality of drive cycles,
pre-magnetizing the inductor,
discharging a parasitic capacitance of the first electronic switch using energy stored in the inductor by the pre-magnetizing, and
after discharging the parasitic capacitance, switching on for an on-period the first electronic switch, and
wherein the control circuit is configured,
to maintain the first electronic switch switched off and the inductor demagnetized for a pause period, before at least one of the plurality of drive cycles.

24. A power converter comprising:
means for pre-magnetizing an inductor connected in series with a first electronic switch, discharging a parasitic capacitance of the first electronic switch using energy stored in the inductor by the pre-magnetizing, and, after discharging the parasitic capacitance, switching on for an on-period the first electronic switch, in at least one of a plurality of drive cycles: and
means for
maintaining the first electronic switch switched off and the inductor demagnetized in a pause period, in at least one of the plurality of drive cycles.
